(19) United States
(12) Patent Application Publication
(10) Pub. No.: US 2025/0016437 A1
(43) Pub. Date: Jan. 9, 2025

(54) IMPORTANT AREA SPECIFICATION SYSTEM, IMPORTANT AREA SPECIFICATION DEVICE, IMPORTANT AREA SPECIFICATION METHOD, AND PROGRAM

(71) Applicant: NEC Corporation, Minato-ku, Tokyo (JP)

(72) Inventors: Kazuki OGATA, Tokyo (JP); Kosei Kobayashi, Tokyo (JP); Yusuke Shinohara, Tokyo (JP); Takanori Iwai, Tokyo (JP); Hayato Itsumi, Tokyo (JP); Koichi Nihei, Tokyo (JP); Kei Yanagisawa, Tokyo (JP)

(73) Assignee: NEC Corporation, Minato-ku, Tokyo (JP)

(21) Appl. No.: 18/708,243

(22) PCT Filed: Nov. 22, 2021
(86) PCT No.: PCT/JP2021/042774

§ 371 Date: May 8, 2024

(51) Int. Cl. H04N 23/60; G06T 7/11; G06V 20/54; H04W 4/029

(52) U.S. Cl. CPC H04N 23/64; G06T 7/11; G06V 20/54; H04W 4/029

(57) ABSTRACT

In order to appropriately specify an important image region in a video, an important region specification system (1) includes: an information acquisition means (11) for acquiring position information of a vehicle; an important region specification means (12) for specifying an important region in an image-capturable region of a camera based on the position information of the vehicle; and an important region notification means (13) for notifying an image processing apparatus, which processes an image taken by the camera, of the important region.

### TECHNICAL FIELD

The present invention relates to an important region specification system, an important region specification apparatus, an important region specification method, and a program.

### BACKGROUND ART

As a method of setting a region in a video taken by a camera, techniques as disclosed in Patent Literatures 1 through 3 are known. Patent Literature 1 discloses an example of a monitoring system using a camera for imaging a pedestrian who crosses a road and an automobile which passes through the road. According to Patent Literature 1, the monitoring system includes a pedestrian detection means and a road information storage region, and sets an important image region based on a position of a pedestrian calculated by the pedestrian detection means and road information accumulated in the road information storage region.

Patent Literature 2 discloses a region-of-interest determination algorithm for a work vehicle which is provided with a function to display, on a monitor, surrounding information of a vehicle body in a mode which is easy for a driver to view while using a bird's-eye image. The region-of-interest determination algorithm sets a region facing the vehicle body in the traveling direction as a region of interest.

Patent Literature 3 discloses a risk region display system including a risk region specification section that specifies a dynamic risk region related to a moving object existing around a vehicle and a static risk region related to a stationary object existing around the vehicle, and a display section that displays these regions.

### CITATION LIST

### Patent Literature

### [Patent Literature 1]

Japanese Patent Application Publication Tokukai No. 2004-320112

### [Patent Literature 2]

Japanese Patent Application Publication Tokukai No. 2020-175890

### [Patent Literature 3]

Japanese Patent Application Publication Tokukai No. 2021-077071

### SUMMARY OF INVENTION

### Technical Problem

However, in Patent Literature 1, a region is set based on the traveling direction of the vehicle, and therefore there is a possibility that a region cannot be appropriately set in a video. In the methods of Patent Literatures 2 and 3, in a case where a video taken by the camera is blurred, there is a possibility that a region cannot be appropriately set.

An example aspect of the present invention is accomplished in view of the above problems, and an example object thereof is to realize a technique which makes it possible to appropriately specify an important image region in a video.

### Solution to Problem

An important region specification system in accordance with an example aspect of the present invention, includes: an information acquisition means for acquiring position information of a vehicle; an important region specification means for specifying an important region in an image-capturable region of a camera based on the position information of the vehicle; and an important region notification means for notifying an image processing apparatus, which processes an image taken by the camera, of the important region.

An important region specification apparatus in accordance with an example aspect of the present invention, includes: an information acquisition means for acquiring position information of a vehicle; an important region specification means for specifying an important region in an image-capturable region of a camera based on the position information of the vehicle; and an important region notification means for notifying an image processing apparatus, which processes an image taken by the camera, of the important region.

An important region specification method in accordance with an example aspect of the present invention, includes: acquiring position information of a vehicle; specifying an important region in an image-capturable region of a camera based on the position information of the vehicle; and notifying an image processing apparatus, which processes an image taken by the camera, of the important region.

A program in accordance with an example aspect of the present invention causes a computer to carry out: a process of acquiring position information of a vehicle; a process of specifying an important region in an image-capturable region of a camera based on the position information of the vehicle; and a process of notifying an image processing apparatus, which processes an image taken by the camera, of the important region.

### Advantageous Effects of Invention

According to an example aspect of the present invention, it is possible to appropriate specify an important image region in a video.

### BRIEF DESCRIPTION OF DRAWINGS

FIG. 1 is a diagram illustrating, with example vehicle and camera, a configuration of an important region specification system in accordance with a first example embodiment of the present invention.

FIG. 2 is a diagram illustrating, with example vehicle and camera, a configuration of an important region specification apparatus in accordance with the first example embodiment of the present invention.

FIG. 3 is a flowchart illustrating a flow of an important region specification method in accordance with the first example embodiment of the present invention.

FIG. 4 is a diagram for describing an operation example of the important region specification apparatus in accordance with the first example embodiment of the present invention.

FIG. 5 is a diagram for describing an operation example of the important region specification apparatus in accordance with the first example embodiment of the present invention.

FIG. 6 is a diagram illustrating, with example vehicle and camera, a configuration of an important region specification system in accordance with a second example embodiment of the present invention.

FIG. 7 is a diagram illustrating, with example vehicle and camera, a configuration of an important region specification apparatus in accordance with the second example embodiment of the present invention.

FIG. 8 is a diagram illustrating, with a peripheral configuration, a configuration of an important region specification apparatus in accordance with a third example embodiment of the present invention.

FIG. 9 is a diagram for describing an example of an important region specification method carried out by the important region specification apparatus in accordance with the third example embodiment of the present invention.

FIG. 10 is a sequence diagram illustrating a flow of operation by the peripheral configuration and the important region specification apparatus in accordance with the third example embodiment of the present invention.

FIG. 11 is a diagram for describing operation of the important region specification apparatus in accordance with the third example embodiment of the present invention.

FIG. 12 is a diagram for describing operation of the important region specification apparatus in accordance with the third example embodiment of the present invention.

FIG. 13 is a diagram for describing operation of the important region specification apparatus in accordance with the third example embodiment of the present invention.

FIG. 14 is a diagram illustrating, with a peripheral configuration, a configuration of an important region specification apparatus in accordance with a fourth example embodiment of the present invention.

FIG. 15 is a diagram for describing an example of an important region specification method carried out by the important region specification apparatus in accordance with the fourth example embodiment of the present invention.

FIG. 16 is a diagram for describing operation of the important region specification apparatus in accordance with the fourth example embodiment of the present invention.

FIG. 17 is a diagram for describing operation of the important region specification apparatus in accordance with the fourth example embodiment of the present invention.

FIG. 18 is a diagram illustrating, with a peripheral configuration, a configuration of an important region specification apparatus in accordance with a fifth example embodiment of the present invention.

FIG. 19 is a block diagram illustrating a configuration of a computer that functions as the important region specification apparatus in accordance with each of the example embodiments.

### EXAMPLE EMBODIMENTS

### First Example Embodiment

First, the following description will discuss a first example embodiment of the present invention, with reference to the drawings. The present example embodiment is a basic form of example embodiments described later. Note that reference signs which are indicated in the drawings and are used in this overview are given to elements for convenience as an example for assisting in understanding, and are not intended to limit the present invention to the illustrated aspects. The connection lines between blocks in the drawings and the like referred to in the descriptions below include both a bidirectional relation and a unidirectional relation. The one-way arrow schematically indicates a flow of a main signal (data), and does not exclude bidirectionality. The connection point of an input and an output of each of the blocks in the drawings may be configured to include a port or an interface. The configurations of these are not illustrated.

### <Important Region Specification System>

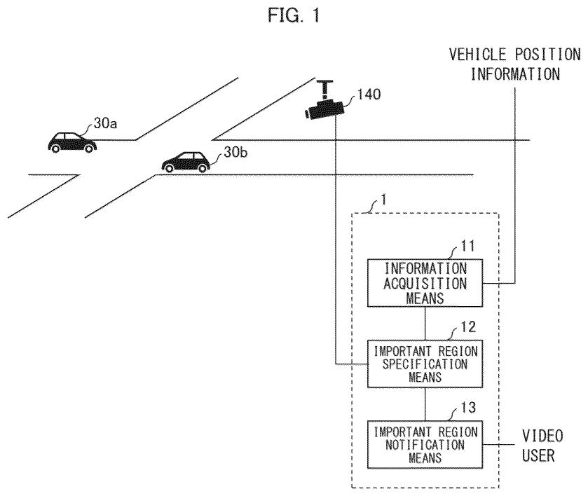

As illustrated in FIG. 1, an important region specification system 1 in accordance with the present example embodiment includes an information acquisition means 11, an important region specification means 12, and an important region notification means 13. The important region specification system 1 acquires, from a camera 140, a captured image including, in its angle of view, one or more vehicles (vehicles 30a and 30b in FIG. 1), and specifies an important region in the captured image which has been acquired.

The information acquisition means 11, the important region specification means 12, and the important region notification means 13 are configured, for example, so as to be communicable to each other via a network. Here, a specific configuration of the network does not limited the present example embodiment but, as an example, it is possible to employ a wireless local area network (LAN), a wired LAN, a wide area network (WAN), a public network, a mobile data communication network, or a combination of these networks.

The information acquisition means 11 acquires pieces of position information of the vehicles 30a and 30b. The pieces of position information of the vehicles 30a and 30b can be acquired from a management system or the like that manages positions of a plurality of vehicles on roads. In such a management system, for example, pieces of position information of a plurality of vehicles of interest are acquired from the respective vehicles via a network. Here, the pieces of position information of the respective vehicles can be acquired by, for example, a global positioning system (GPS) apparatus mounted on each of the vehicles. Examples of the above-described management system include an information processing system for a vehicle that manages positions of vehicles and carries out provision of traffic jam information and route guidance. Note, however, that the present example embodiment is not limited to these examples. For example, the management system may acquire position information from a terminal apparatus carried by a driver of each of the vehicles, and use the acquired position information as position information of that vehicle.

The information acquisition means 11 may be configured to acquire position information pertaining to a vehicle which is located around the camera 140 that is provided so that an image of the road can be taken. For example, the information acquisition means 11 acquires pieces of position information of a plurality of vehicles of interest and position information of the camera 140, and identifies a vehicle which is located around the camera 140 by comparing the pieces of position information of the respective plurality of vehicles with the position information of the camera 140. It is possible to employ a configuration in which position information of the identified vehicle is then provided to the important region specification means 12 (described later).

Note that the phrase “around the camera 140” refers to, for example, a range included within a predetermined distance from the camera 140. For example, the information acquisition means 11 identifies a vehicle which exists within a several tens of meters from the camera 140 by comparing position information of the vehicle with the position information of the camera 140, and provides the position information of the identified vehicle to the important region specification means 12 (described later).

The important region specification means 12 specifies an important region in an image-capturable region of the camera 140 based on the pieces of position information of the vehicles 30a and 30b. Here, the image-capturable region refers to, for example, a range in a target space which the camera 140 can record as an image, and is defined by an angle of view of the camera 140. In a case where the camera 140 has any of functions of panning, tilting, and zooming, the image-capturable region changes according to the panning, tilting, and zooming.

The “important region” is also called a region of interest (ROI), and refers to, for example, a region having importance higher than the other regions in the image. Note that the above description is only an example, and the term “important region” does not limited the present example embodiment. In the present example embodiment, the important region can be expressed by coordinates in a target space. Note, however, that the present example embodiment is not limited thereto. For example, the important region may be expressed by coordinates in a captured image.

For example, the important region specification means 12 specifies, as an important region, a predetermined region in front of the vehicle based on the position information of the vehicle. Here, the traveling direction of the vehicle can be determined (predicted) by the important region specification means 12 based on, for example, the position information of the vehicle. For example, the important region specification means 12 can identify, based on a position of the vehicle in an image taken by the camera 140, which one of a right lane and a left lane the vehicle is traveling, and identify the traveling direction of the vehicle in accordance with the identified lane. In a case where the important region specification means 12 acquires the position information of the vehicle as time series data, it is also possible to identify the traveling direction of the vehicle based on the change of the position.

The important region notification means 13 notifies a predetermined image processing apparatus of the important region. Examples of the predetermined image processing apparatus include the camera 140, an apparatus that uses an image taken by the camera 140, and the like. The important region notified to such apparatuses is used as information for specifying a range that is to be subjected to image processing or object recognition processing, and a region that attracts the attention of a viewer of the image.

For example, in a case where the predetermined image processing apparatus is the camera 140, the camera 140 can carry out sharpening, emphasis processing, or the like of an important region image in an image to be transmitted. In a case where the predetermined image processing apparatus is an image display apparatus, the image display apparatus can carry out sharpening or the like of an important region image in the received image, and display the image.

Sharpening of an image refers to making a predetermined region in the image have higher image quality (i.e., sharper) than the other regions. For example, an image can be sharpened by carrying out compression (encoding) on the camera side so that deterioration in image quality of the target region is suppressed. An image can be sharpened by improving, with use of a super-resolution technique or the like, image quality of the target region in the image compressed (encoded) by the camera.

### (Example Advantage of Important Region Specification System 1)

As described above, according to the important region specification system 1 in accordance with the present example embodiment, the important region specification means 12 specifies an important region in the image-capturable region of the camera 140 based on the pieces of position information of the vehicles 30a and 30b. Therefore, the important region specification means 12 can appropriately specify an image region that is important for each of the vehicles 30a and 30b. The important regions can be used in visual monitoring of an image by a video user (e.g., a human) and in various kinds of image processing by a computer.

In a case where the important region notification means 13 notifies, for example, a remote monitoring center, which carries out visual monitoring of an image, of important regions for the vehicles 30a and 30b, the remote monitoring center can carry out various kinds of image processing using the important regions for the vehicles 30a and 30b. This makes it possible to allow a self-driving vehicle to carry out, based on the image processing result, operation to evade an abnormal location or an accident on a road, which is difficult for the self-driving vehicle to notice.

The important region specification means 12 specifies an important region in the image-capturable region of the camera 140 based on position information of a vehicle. Therefore, even in a case where a vehicle appearing in an image taken by the camera 140 is far away or a video is blurred due to weather, dirt on a lens, or the like, it is possible to specify an important region.

Even in a case where, in a system in which an image processing apparatus transmits an image to an image display apparatus via a network, a band of the network is squeezed, the image processing apparatus makes an important region have higher image quality and makes a region other than the important region have lower image quality based on the specified important region, and this makes it possible to provide an image with which it is possible to carry out visual monitoring and image processing.

### <Important Region Specification Apparatus>

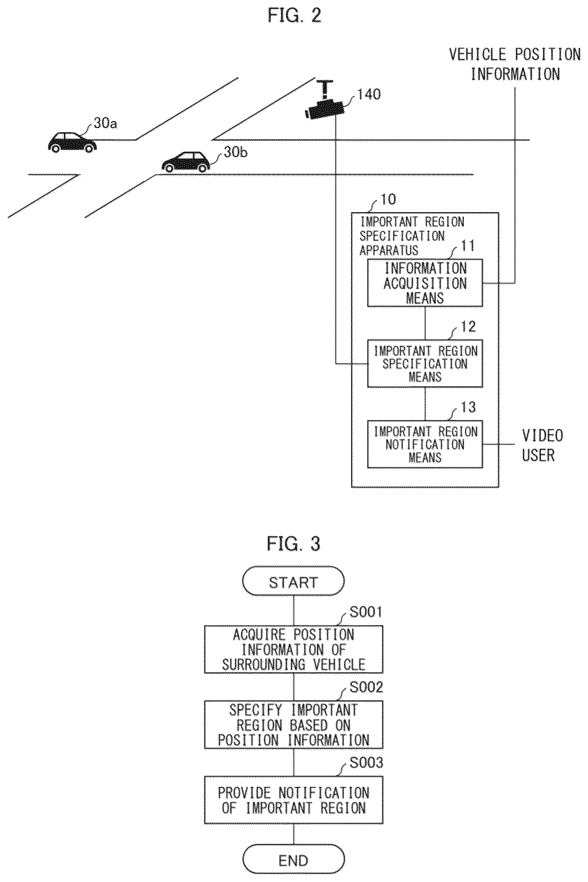

FIG. 2 is a diagram illustrating, with example vehicle and camera, a configuration of an important region specification apparatus in accordance with the present example embodiment. As illustrated in FIG. 2, an important region specification apparatus 10 in accordance with the present example embodiment has a configuration in which the foregoing information acquisition means 11, important region specification means 12, and important region notification means 13 are collected together in a single apparatus. The important region specification apparatus 10 can be configured by a server or the like which is provided on a cloud infrastructure or the Internet. The important region specification apparatus 10 can be a multi-access edge computing (MEC) server or a mobile edge computing (MEC) server which is provided at a position close to the camera 140.

The information acquisition means 11 acquires pieces of position information of the vehicles 30a and 30b. The pieces of position information of the vehicles 30a and 30b can be acquired from a management system or the like that manages positions of a plurality of vehicles on roads.

The important region specification means 12 specifies important regions in the image-capturable region of the camera 140 based on the pieces of position information of the vehicles 30a and 30b. The important region is also called a region of interest (ROI), and refers to, for example, a region having importance higher than the other regions in the image.

For example, the important region specification means 12 specifies, as an important region, a predetermined region in front of the vehicle based on the position information of the vehicle. Here, the traveling direction of the vehicle can be determined (predicted) by the important region specification means 12 based on, for example, the position information of the vehicle.

The important region notification means 13 notifies a predetermined image processing apparatus of an important region. Examples of the predetermined image processing apparatus include the camera 140, an apparatus that uses an image taken by the camera 140, and the like.

### (Example Advantage of Important Region Specification Apparatus)

As described above, according to the important region specification apparatus 10 in accordance with the present example embodiment, the important region specification means 12 can appropriately specify an image region that is important for each of the vehicles 30a and 30b. The important regions can be used in visual monitoring of an image by a video user (e.g., a human) and in various kinds of image processing by a computer.

In a case where the important region notification means 13 notifies, for example, a remote monitoring center, which carries out visual monitoring of an image, of important regions for the vehicles 30a and 30b, the remote monitoring center can carry out various kinds of image processing using the important regions for the vehicles 30a and 30b. This makes it possible to allow a self-driving vehicle to carry out, based on the image processing result, operation to evade an abnormal location or an accident on a road, which is difficult for the self-driving vehicle to notice.

### <Important Region Specification Method>

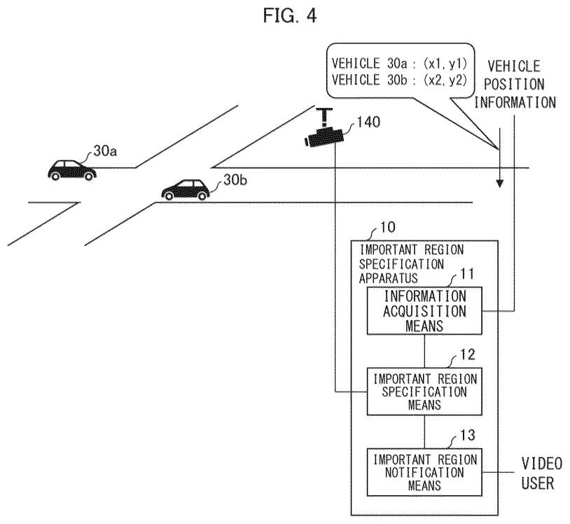

FIG. 3 is a flowchart illustrating a flow of an important region specification method in accordance with the first example embodiment of the present invention. First, the information acquisition means 11 acquires pieces of position information of surrounding vehicles 30a and 30b (step S001). For example, as illustrated in FIG. 4, the information acquisition means 11 acquires, as the pieces of position information of the vehicles 30a and 30b, position information (x1,y1) of the vehicle 30a and position information (x2,y2) of the vehicle 30b. Here, the pieces of position information (x1,y1) and (x2,y2) are each, for example, latitude information and longitude information of the vehicles 30a and 30b which are acquired by a GPS apparatus.

The pieces of position information (x1, y1) and (x2,y2) can be, for example, coordinates of the vehicle 30a and the vehicle 30b in an image taken by the camera 140. For example, in a management system or the like that manages positions of a plurality of vehicles on roads, object recognition processing is carried out on an image taken by the camera 140, and it is thus possible to identify the vehicle 30a and the vehicle 30b. The management system or the like can set coordinates of the vehicle 30a and the vehicle 30b in the image taken by the camera 140 as the above-described pieces of position information.

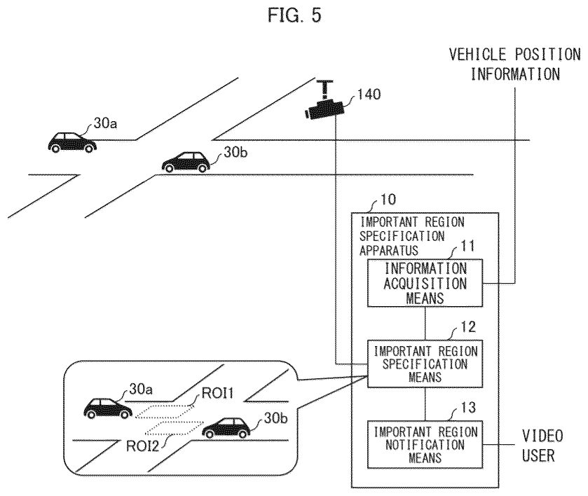

Next, the important region specification means 12 specifies an important region in an image-capturable region of the camera 140 based on the pieces of position information of the vehicles 30a and 30b (step S002). For example, the important region specification means 12 specifies, as important regions ROI1 and ROI2, predetermined ranges in front of the respective vehicles 30a and 30b, as illustrated in FIG. 5.

Here, traveling directions of the vehicles can be determined (predicted) by the important region specification means 12 based on, for example, the pieces of position information of the vehicles 30a and 30b. For example, the important region specification means 12 can identify, based on positions of the vehicles 30a and 30b in an image taken by the camera 140, which one of a right lane and a left lane each of the vehicles 30a and 30b is traveling, and identify the traveling direction of each of the vehicles 30a and 30b in accordance with the identified lane. In a case where the important region specification means 12 acquires the pieces of position information of the vehicles 30a and 30b as time series data, it is also possible to identify the traveling direction of each of the vehicles 30a and 30b based on the change of the position. The important region specification means 12 specifies, as the important regions ROI1 and ROI2, predetermined ranges in the identified traveling directions of the respective vehicles 30a and 30b.

For example, the important region specification means 12 specifies, as an important region, a predetermined region in front of a vehicle based on position information of the vehicle. Here, the traveling direction of the vehicle can be determined (predicted) by the important region specification means 12 based on, for example, the position information of the vehicle.

Lastly, the important region notification means 13 notifies a predetermined image processing apparatus of the important regions ROI1 and ROI2 (step S003). Examples of the predetermined image processing apparatus include the camera 140, an apparatus that uses an image taken by the camera 140, and the like.

### (Example Advantage of Important Region Specification Method)

As described above, according to the important region specification method in accordance with the present example embodiment, the important region specification means 12 can appropriately specify an image region that is important for each of the vehicles 30a and 30b. The important regions can be used in visual monitoring of an image by a video user (e.g., a human) and in various kinds of image processing by a computer.

In a case where the important region notification means 13 notifies, for example, a remote monitoring center, which carries out visual monitoring of an image, of important regions for the vehicles 30a and 30b, the remote monitoring center can carry out various kinds of image processing using the important regions for the vehicles 30a and 30b. This makes it possible to allow a self-driving vehicle to carry out, based on the image processing result, operation to evade an abnormal location or an accident on a road, which is difficult for the self-driving vehicle to notice.

### Second Example Embodiment

The following description will discuss a second example embodiment of the present invention in detail, with reference to the drawings.

### <Important Region Specification System>

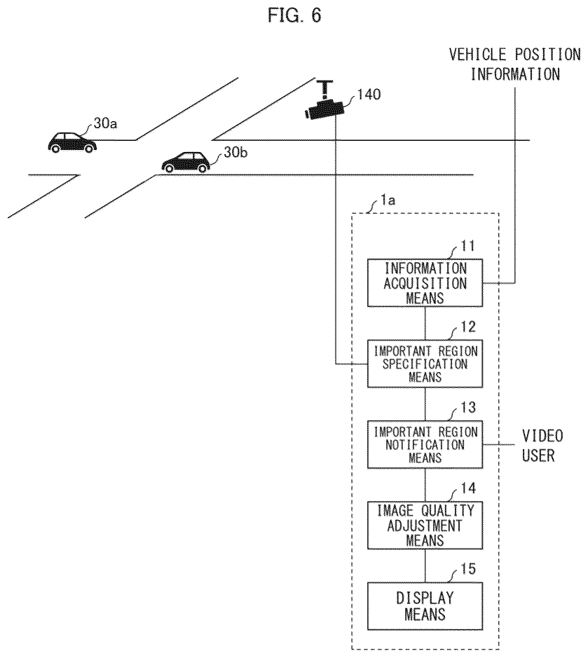

As illustrated in FIG. 6, the important region specification system 1a in accordance with the present example embodiment includes an information acquisition means 11, an important region specification means 12, an important region notification means 13, an image quality adjustment means 14, and a display means 15. The same reference numerals are given to constituent elements which have functions identical with those described in the first example embodiment, and descriptions as to such constituent elements are omitted as appropriate.

The information acquisition means 11 acquires pieces of position information of the vehicles 30a and 30b. The pieces of position information of the vehicles 30a and 30b can be acquired from a management system or the like that manages positions of a plurality of vehicles on roads.

The important region specification means 12 specifies an important region in an image-capturable region of a camera 140 based on the pieces of position information of the vehicles 30a and 30b. The important region is also called a region of interest (ROI), and refers to, for example, a region having importance higher than the other regions in the image.

The important region notification means 13 notifies a predetermined image processing apparatus of an important region. Examples of the predetermined image processing apparatus include the camera 140, an apparatus that uses an image taken by the camera 140, and the like.

The image quality adjustment means 14 changes, based on information of a specified important region, image quality of an image taken by the camera 140. For example, the image quality adjustment means 14 instructs the camera 140 to carry out compression (encoding) for suppressing deterioration of an image in the important region. For example, in a case where the camera 140 compresses a video in a format of moving picture experts group (MPEG), a compression ratio can be controlled by changing quantization parameters. When the camera 140 has received an instruction to suppress deterioration of an image in the important region, control is carried out so that the quantization parameters are changed to lower the compression ratio of the image in the important region. The image quality adjustment means 14 may improve, using a super-resolution technique or the like, image quality of an image in an important region of an image which has been compressed (encoded) by the camera 140.

The display means 15 displays, while using the important region, an image taken by the camera 140. For example, when displaying an image taken by the camera 140, the display means 15 displays the image so that an image in the important region can be distinguished from the other image. The display means 15 may display an image whose image quality has been changed by the image quality adjustment means 14.

### (Example Advantage of Important Region Specification System 1a)

As described above, according to the important region specification system 1a in accordance with the present example embodiment, the image quality adjustment means 14 changes, based on information of a specified important region, image quality of an image taken by the camera 140. Therefore, by changing image quality so that deterioration of an image in the important region is suppressed, it is possible to more minutely carry out visual monitoring of an image by a human and various kinds of image processing by a computer.

Moreover, the display means 15 displays, while using the important region, an image taken by the camera 140. Therefore, it is possible to more minutely carry out visual monitoring of an image and the like by a human.

### <Important Region Specification Apparatus>

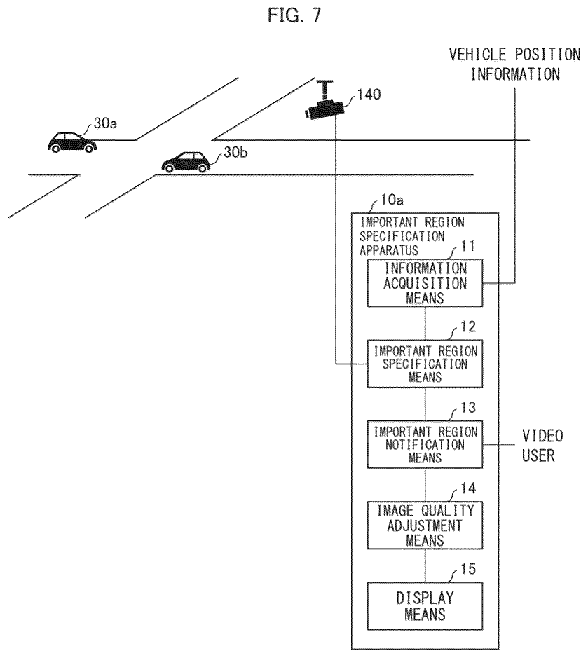

As illustrated in FIG. 7, an important region specification apparatus 10a in accordance with the present example embodiment includes an information acquisition means 11, an important region specification means 12, an important region notification means 13, an image quality adjustment means 14, and a display means 15. The same reference numerals are given to constituent elements which have functions identical with those described in the first example embodiment, and descriptions as to such constituent elements are omitted as appropriate.

The information acquisition means 11 acquires pieces of position information of vehicles 30a and 30b. The pieces of position information of the vehicles 30a and 30b can be acquired from a management system or the like that manages positions of a plurality of vehicles on roads.

The important region specification means 12 specifies an important region in an image-capturable region of a camera 140 based on the pieces of position information of the vehicles 30a and 30b. The important region is also called a region of interest (ROI), and refers to, for example, a region having importance higher than the other regions in the image.

The important region notification means 13 notifies a predetermined image processing apparatus of an important region. Examples of the predetermined image processing apparatus include the camera 140, an apparatus that uses an image taken by the camera 140, and the like.

The image quality adjustment means 14 changes, based on information of a specified important region, image quality of an image taken by the camera 140. For example, the image quality adjustment means 14 instructs the camera 140 to carry out compression (encoding) for suppressing deterioration of an image in the important region.

The display means 15 displays, while using the important region, an image taken by the camera 140. For example, when displaying an image taken by the camera 140, the display means 15 displays the image so that an image in the important region can be distinguished from the other image. The display means 15 may display an image whose image quality has been changed by the image quality adjustment means 14.

### (Example Advantage of Important Region Specification Apparatus 10a)

As described above, according to the important region specification apparatus 10a in accordance with the present example embodiment, the image quality adjustment means 14 changes, based on information of a specified important region, image quality of an image taken by the camera 140. Therefore, by changing image quality so that deterioration of an image in the important region is suppressed, it is possible to more minutely carry out visual monitoring of an image by a human and various kinds of image processing by a computer.

Moreover, the display means 15 displays, while using the important region, an image taken by the camera 140. Therefore, it is possible to more minutely carry out visual monitoring of an image and the like by a human.

### Third Example Embodiment

The following description will discuss in detail a third example embodiment of the present invention, with reference to the drawings. An important region specification apparatus 100 in accordance with the present example embodiment is connected to a vehicle to everything (V2X) information provision apparatus 200 and a server 300 via, for example, a network.

### <Configuration of Important Region Specification Apparatus 100>

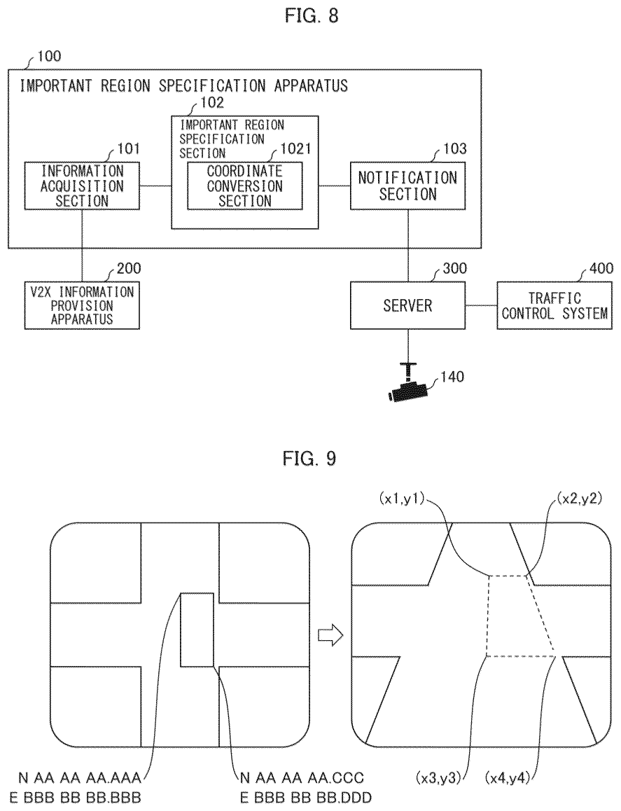

The following description will discuss a configuration of the important region specification apparatus 100 in accordance with the present example embodiment, with reference to FIG. 8. FIG. 8 is a diagram illustrating, with a peripheral configuration, the configuration of the important region specification apparatus 100 in accordance with the second example embodiment. As illustrated in FIG. 8, the important region specification apparatus 100 includes an information acquisition section 101, an important region specification section 102, and a notification section 103. The information acquisition section configured to implement the information acquisition means in the present example embodiment. The important region specification section 102 is configured to implement the important region specification means in the present example embodiment. The notification section 103 is configured to implement the important region notification means in the present example embodiment.

As illustrated in FIG. 8, a system including the important region specification apparatus 100 includes the V2X information provision apparatus 200, the important region specification apparatus 100, the server 300, a camera 140, and a traffic control system 400.

The V2X information provision apparatus 200 provides V2X information using a V2X communication technique. The V2X is a communication technique for transmitting and receiving various kinds of information via vehicle-to-infrastructure (V2I) communication or a cloud. Examples of data exchanged by the V2X communication technique include road traffic information, data pertaining to a behavior of an automobile, data pertaining to formation and follow-up travelling, and data pertaining to automatic driving.

The V2X information provision apparatus 200 can provide, among these pieces of data, data pertaining to a behavior of an automobile (in particular, information on a traveling area, a traveling speed, a traveling distance, and a vehicle type of the automobile, driving characteristics such as acceleration and deceleration and operation information of a handle, an accelerator, and blinkers, a status of the automobile, and the like) to the important region specification apparatus 100.

The V2X information includes position information of a vehicle which is located around the camera 140. Examples of the V2X information provision apparatus 200 include a system for managing a position of a vehicle, as well as a terminal, a roadside machine, and the like that can acquire, from a system of that type, position information of a vehicle located around the camera 140. The V2X information provision apparatus 200 can be a terminal that receives V2X information from the traffic control system 400 and provides the V2X information to the important region specification apparatus 100.

The camera 140 is a camera which is installed around a road and is provided so as to be able to take images of a vehicle and the like that pass through the road. The camera 140 can be a camera that is provided to a signal post of a traffic light at an intersection, a power pole, or the like.

The important region specification apparatus 100 specifies, based on the V2X information acquired from the V2X information provision apparatus 200, an important region in an image provided from the server 300, and notifies the server 300 of the important region.

The server 300 transmits an image taken by the camera 140 to the important region specification apparatus 100. The server 300 transmits, to the traffic control system 400, an image acquired from the camera 140 and information of an important region sent from the important region specification apparatus 100.

The traffic control system 400 carries out, with use of the image acquired from the camera 140 and the information of the important region sent from the important region specification apparatus 100, presentation of information or the like to a control person who carries out traffic control work. Specifically, the traffic control system 400 includes a display means for displaying an image taken by the camera 140, and the display means displays the image using the important region. For example, the display means of the traffic control system 400 locally carries out sharpening or object recognition in the image using information of the important region sent from the important region specification apparatus 100, and outputs a result thereof.

Examples of a method of sharpening an image include: a method in which the camera 140 provides an instruction of compression (encoding) for suppressing deterioration in image quality of a target region; and a method in which image quality of a target region in an image which has been compressed (encoded) by the camera 140 is improved with use of a super-resolution technique or the like.

It is possible to provide, to any one of the camera 140, the important region specification apparatus 100, and the server 300, an image quality adjustment means for changing image quality of an image with use of information of the important region. With the above configuration, it is possible to reduce a load on the traffic control system 400 side.

The information acquisition section 101 provides the important region specification section 102 with a vehicle and position information thereof included in V2X information acquired from the V2X information provision apparatus 200.

The important region specification section 102 specifies a range which is set to be an important region based on position information of a vehicle, and specifies the important region by converting the range into coordinates in the image taken by the camera. Specifically, the important region specification section 102 refers to the position information of the vehicle included in the V2X information, and specifies an important region in a target space in the image-capturable range of the camera 140 based on a position of the vehicle in the image-capturable range. As a method of specifying the important region, it is possible to employ a method in which a region is selected by applying a predetermined region specification rule to a position of a vehicle.

The important region specification section 102 further includes a coordinate conversion section 1021. The coordinate conversion section 1021 converts, for example, region information, which is expressed by a latitude and longitude or the like and which has been acquired from the V2X information provision apparatus 200, into coordinates in an image taken by the camera 140.

FIG. 9 is a diagram for describing an example of an important region specification method carried out by the important region specification apparatus 100 in accordance with the present example embodiment. The important region specification section 102 specifies an important region in a target space in the image-capturable range based on the position information of the vehicle acquired from the V2X information provision apparatus 200. For example, in the left part of FIG. 9, an important region is specified in a target space around an intersection by specifying a latitude and longitude of an upper left corner of a rectangle and a latitude and longitude of a lower right corner of the rectangle. In the left part of FIG. 9, “N AA AA AA.AAA”, “E BBB BB BB. BBB”, “N AA AA AA.CCC”, and “E BBB BB BB.DDD” each represent latitude information or longitude information acquired from the V2X information provision apparatus 200.

For example, the coordinate conversion section 1021 converts latitude-longitude position information in a target space in an image-capturable range illustrated in the left part of FIG. 9 into a relative position with respect to a lower left position of the left part. For example, the coordinate conversion section 1021 defines lower left coordinates as (0,0) and upper right coordinates as (1023,1023) in the target space of the image-capturable range, and calculates relative positions of four corners of the important region.

The coordinate conversion section 1021 stores, in advance, a table indicating a correspondence between a relative position in a target space in the image-capturable range and corresponding coordinates in an image taken by the camera 140. With reference to the table, the coordinate conversion section 1021 converts relative positions of four corners of an important region in the target space in the image-capturable range into corresponding coordinates in an image taken by the camera 140. In a case where the coordinates of the important region in the target space in the image-capturable range are between relative coordinates that are stored in the table, an interpolation process may be carried out to convert the coordinates into corresponding coordinates in the image taken by the camera 140.

The coordinate conversion section 1021 converts the important region which is described in such a latitude and a longitude into coordinates in an image taken by the camera 140. For example, the right part of FIG. 9 indicates an important region which is defined by four points. Coordinates (x1,y1), (x2,y2), (x3,y3), and (x4,y4) in the important region in the right part of FIG. 9 correspond to coordinates of the four corners of the important region in the left part of FIG. 9.

The important region specification section 102 outputs, to the notification section 103, the important region which has been specified as described above. Note that a shape of the important region does not need to be a rectangle, and can be an arbitrary shape based on a rule set in advance (e.g., ROI2 in FIG. 11).

The important region specification section 102 refers to the position information of the vehicle acquired by the information acquisition section 101 and determines, as a vehicle for which an important region is to be specified, a vehicle included in the target space in the image-capturable range illustrated in the left part of FIG. 9. The coordinate conversion section 1021 carries out association with a vehicle in an image taken by the camera 140 by converting a latitude and longitude of a vehicle included in a target space in the image-capturable range into coordinates in the image taken by the camera 140.

The notification section 103 transmits information of the specified important region to the server 300. FIG. 9 indicates an example in which the number of important regions is one, in order to simplify the descriptions. Note, however, that the number of important regions may be two or more.

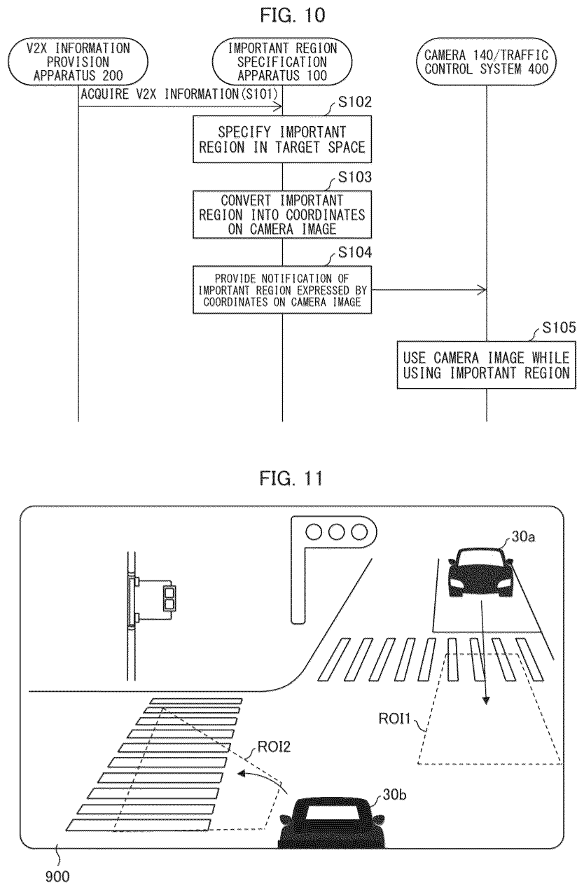

Next, the following description will discuss operation of the important region specification apparatus 100 in accordance with the present example embodiment in detail, with reference to the drawings. FIG. 10 is a sequence diagram for describing operation of the third example embodiment of the present invention. First, the important region specification apparatus 100 acquires, from the V2X information provision apparatus 200, V2X information including position information of a vehicle around an intersection where the camera 140 is provided, at a predetermined time interval or at a timing when the vehicle has approached an area around the camera 140 (step S101).

Next, the important region specification apparatus 100 refers to the position information of the vehicle included in the V2X information, and specifies an important region in a target space in the image-capturable range of the camera 140 based on a position of the vehicle that is in the image-capturable range (step S102). This operation corresponds to operation of specifying a rectangle in the intersection in the left part of FIG. 9.

Note that, in a case where an area for which V2X information is to be transmitted is wide, a specification target of the important region may include a position of a vehicle that may move in the image-capturable range of the camera 140, as well as a vehicle that is positioned in the image-capturable range of the camera 140.

When specifying an important region, the important region specification apparatus 100 may select, with a predetermined rule, a vehicle for which an important region is to be specified from among vehicles that are in the image-capturable range. With the above configuration, it is possible to reduce a processing load of the important region specification apparatus 100. Examples of the predetermined rule include: a rule in which a vehicle is selected based on a position of a vehicle in the image (e.g., a distant vehicle is not selected) or a traveling direction (e.g., a vehicle driving away from the camera 140 is not selected); and a rule in which the number of vehicles to be selected is restricted based on the number of important regions to be specified.

Next, the important region specification apparatus 100 converts the specified important region in the target space into coordinates on the image taken by the camera 140 that has been obtained via the server 300 (step S103). This operation corresponds to operation of specifying an important region which is defined by coordinates (x1,y1) to (x4,y4) on an image of the intersection illustrated in the right part of FIG. 9.

Next, the important region specification apparatus 100 notifies, via the server 300, the traffic control system 400 of the important region expressed by coordinates on the image taken by the camera 140 (step S104).

Lastly, the traffic control system 400 carries out a process using the important region notified by the important region specification apparatus 100 (step S105). For example, the traffic control system 400 carries out object recognition on an image in the important region notified by the important region specification apparatus 100, and displays a result thereof to the control person. The traffic control system 400 can transmit the result of the object recognition to a self-driving vehicle or the like which is under control of the traffic control system 400. The display means may display, in an image, an image of the important region in a mode in which the important region is distinguishable from the other image. In this case, the traffic control system 400 carries out a process of indicating the important region on the image taken by the camera 140 in a mode in which the important region can be easily visually recognized.

Next, the following description will discuss a region specification rule used by the important region specification apparatus 100 to specify an important region in more detail, with reference to the drawings. The important region specification apparatus 100 can specify an important region using a region specification rule in which a predetermined range in a traveling direction of a vehicle is specified as an important region. FIG. 11 and FIG. 12 are diagrams each illustrating an example of specifying an important region in this case.

In FIG. 11, for a vehicle 30a coming straight from the front in an image 900, a predetermined range in a traveling direction of the vehicle 30a is specified as an important region ROI1. Similarly, for a vehicle 30b positioned in a left-turn lane, a predetermined range in a traveling direction of the vehicle 30b is specified as an important region ROI2. In the example illustrated in FIG. 11, a width of the important region ROI1 is set to be equivalent to a vehicle width of the vehicle 30a, and a length is set to be a region through which the vehicle 30a passes after a predetermined time (e.g., after a few seconds). Note that the length of the important region ROI1 can be a fixed value such as a range of several meters in front of the vehicle 30a. In the example illustrated in FIG. 11, the important region ROI2 has a substantially trapezoidal shape in which a width equivalent to a vehicle width of the vehicle 30b becomes greater in a direction away from the vehicle 30b. By setting the important region to be the substantially trapezoidal shape as described above, it is possible to cover an area where a moving object (pedestrian) that may intersect with the vehicle 30b exists. In addition, by setting the important region to be the substantially trapezoidal shape, it is possible to cover a difference in turning radius (large radius turning, small radius turning) for each vehicle when turning left or right.

As illustrated in FIG. 12, the important regions ROI1 and ROI2 change in accordance with movements of the vehicles 30a and 30b in the image 900. With the above configuration, it is possible to obtain a latest road surface condition or a result of object recognition.

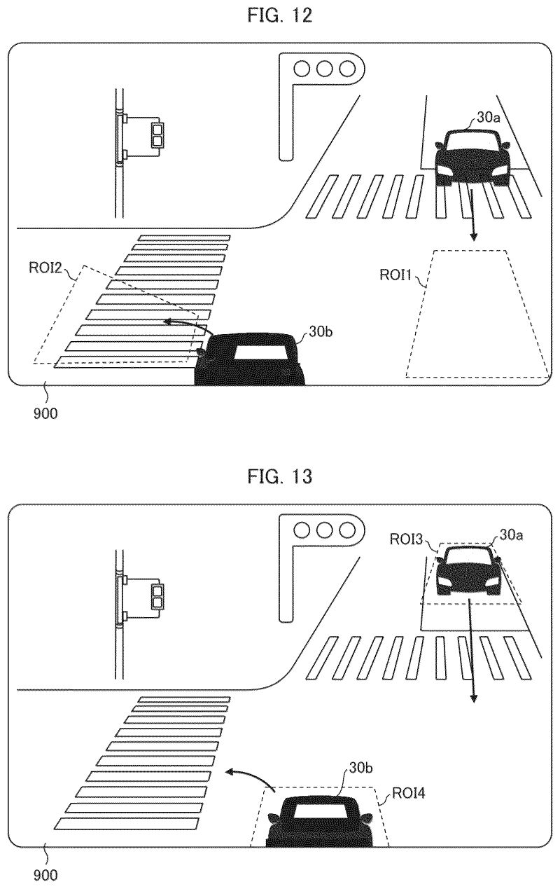

Note that the region specification rule is not limited to the examples illustrated in FIG. 11 and FIG. 12. For example, as illustrated in FIG. 13, it is possible to use a region specification rule in which an area surrounding a position of a vehicle is set to be an important region. In the example illustrated in FIG. 13, important regions ROI3 and ROI4 are specified in respective predetermined ranges around the vehicles 30a and 30b in the image 900. By specifying such important regions, it is possible to efficiently identify a vehicle and ascertain a traffic flow. In the example illustrated in FIG. 13, the important regions ROI3 and ROI4 are specified in the predetermined ranges around the vehicles 30a and 30b. Note, however, that areas around front and rear parts of the vehicles 30a and 30b, where license plates are typically provided, may be specified as important regions.

In the present example embodiment, the example has been described in which the important region is notified to the traffic control system 400. Note, however, that the important region may be notified also to the camera 140. With the above configuration, for example, the camera 140 can change a method of video compression so that image quality of the important region notified by the important region specification apparatus 100 becomes higher. Although the example has been described in which the traffic control system 400 carries out the process using the important region, the server 300 may carry out a process using the important region. With the above configuration, it is possible to reduce a load on the traffic control system 400 side.

As described above, according to the important region specification apparatus 100 in accordance with the present example embodiment, the important region specification section 102 specifies a range, which is to be set to the important region, based on the position information of the vehicle, and specifies the important region by converting the range into coordinates in the image taken by the camera. Therefore, an important region can be specified at an appropriate position in an image taken by the camera.

### Fourth Example Embodiment

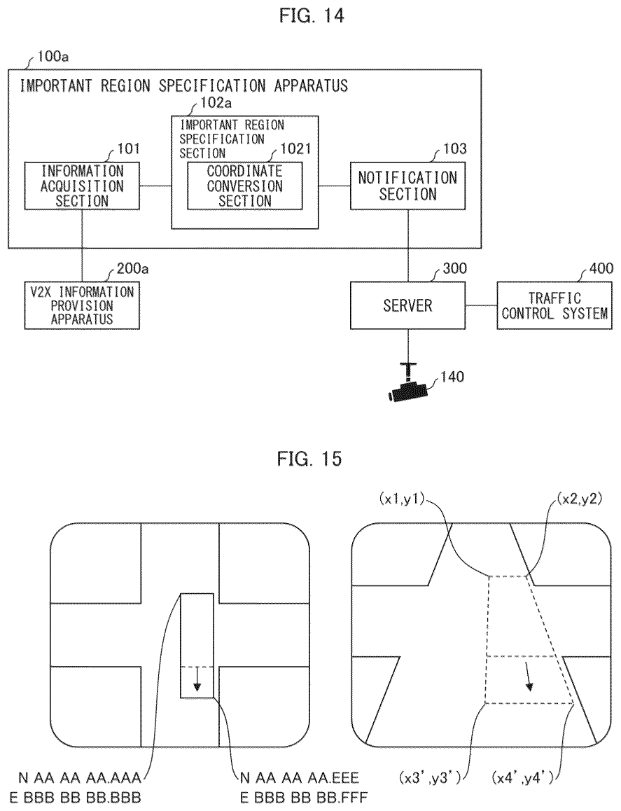

The following description will discuss a fourth example embodiment of the present invention in detail, with reference to the drawings. FIG. 14 is a diagram illustrating, with a peripheral configuration, a configuration of an important region specification apparatus 100a in accordance with the fourth example embodiment of the present invention. An important region specification apparatus 100a in accordance with the present example embodiment is connected to a V2X information provision apparatus 200a and a server 300 via, for example, a network. The same reference numerals are given to constituent elements which have functions identical with those described in the third example embodiment, and descriptions as to such constituent elements are omitted as appropriate.

Note that the important region specification apparatus 100a in accordance with the present example embodiment is different in configuration n from the important region specification apparatus 100 in accordance with the third example embodiment illustrated in FIG. 8 in the following two points. The first difference is that the V2X information provision apparatus 200a provides the important region specification apparatus 100a with speed information of a vehicle and the like in addition to a position of the vehicle. The second difference is that an important region specification section 102a of the important region specification apparatus 100a specifies an important region using information (such as speed information of the vehicle) other than the position of the vehicle.

The V2X information provision apparatus 200a provides the important region specification apparatus 100a with, in addition to a position of a vehicle, information such as speed information and a vehicle type of the vehicle, driving characteristics such as acceleration and deceleration, operation information of a handle, an accelerator, and blinkers, and a status of an automobile. The information acquisition section 101 acquires at least one selected from the group consisting of a speed, a vehicle type, and acceleration of the vehicle, and pieces of operation information of a handle, an accelerator, and blinkers.

The important region specification section 102a specifies an important region in an image-capturable region of a camera based on position information of a vehicle and at least one selected from the group consisting of a speed, a vehicle type, and acceleration of the vehicle and pieces of operation information of a handle, an accelerator, and blinkers.

For example, the important region specification section 102a refers to information such as position information and speed information of a vehicle included in V2X information provided from the V2X information provision apparatus 200a, and specifies an important region in a target space in an image-capturable range of the camera 140 based on a position of the vehicle that is in the image-capturable range.

FIG. 15 is a diagram for describing an example of an important region specification method carried out by the important region specification apparatus 100a in accordance with the present example embodiment. The important region specification section 102a specifies an important region in a target space in the image-capturable range with reference to the position information of the vehicle acquired from the V2X information provision apparatus 200a. At this time, the important region specification section 102a enlarges or reduces the range of the important region based on the speed information of the vehicle acquired from the V2X information provision apparatus 200a.

For example, as illustrated in the left part of FIG. 9, it is assumed that an important region is specified in a target space around an intersection by specifying a latitude and longitude of an upper left corner of a rectangle and a latitude and longitude of a lower right corner of the rectangle. In a case where the speed of the vehicle acquired from the V2X information provision apparatus 200a is higher than a predetermined threshold, the important region specification section 102a carries out a process of enlarging the important region in the traveling direction of the vehicle as illustrated in the left part of FIG. 15, and enlarges the important region to “N AA AA AA.EEE” and “E BBB BB BB.FFF”.

The coordinate conversion section 1021 converts latitude-longitude position information in a target space in the image-capturable range into corresponding coordinates in an image taken by the camera 140. For example, the right part of FIG. 15 indicates an important region which is defined by four points. Coordinates (x1,y1), (x2, y2), (x3′,y3′), and (x4′,y4′) in the important region in the right part of FIG. 15 correspond to coordinates of the four corners of the important region in the left part of FIG. 15. The important region specification section 102a outputs, to the notification section 103, the enlarged important region.

Note that, in the example of FIG. 15, the speed of the vehicle is higher than the predetermined threshold, and therefore the process of enlarging the important region is carried out. However, in a case where the speed of the vehicle is lower than the predetermined threshold, it is also possible to carry out a process of reducing the important region.

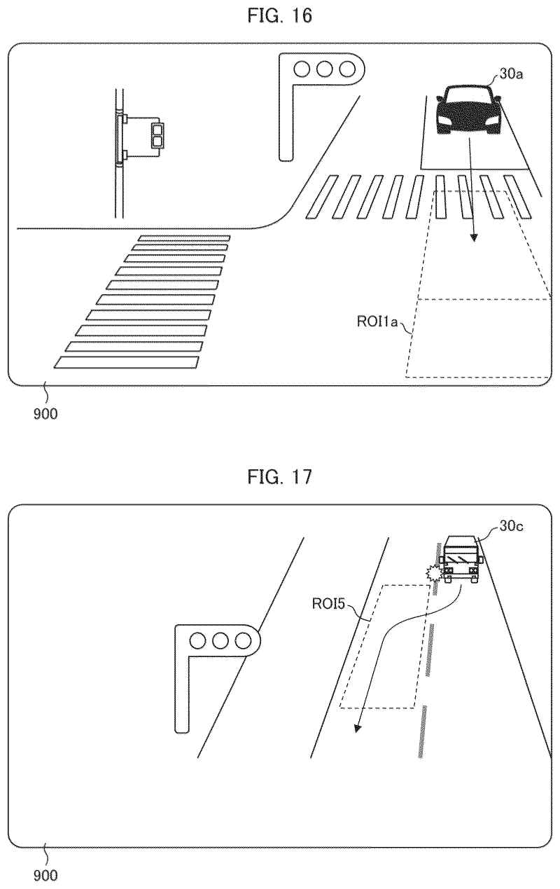

FIG. 16 is a diagram for describing operation of the important region specification apparatus in accordance with the fourth example embodiment of the present invention. In FIG. 16, the important region specification section 102a specifies, for a vehicle 30a coming straight from the front in the image 900, an enlarged important region ROI1a in accordance with a speed of the vehicle 30a.

The important region specification section 102a can specify an important region using, in addition to the speed of the vehicle, a vehicle type, acceleration, pieces of operation information of a handle, an accelerator, blinkers, and the like. For example, as illustrated in FIG. 17, in a case where a blinker indicating that a bus 30c changes a lane to the right side (the left side in FIG. 17) with respect to a traveling direction is blinked, the important region specification section 102a acquires operation information of blinking of the blinker of the bus 30c from the V2X information provision apparatus 200a, and specifies, on a lane after the lane change, an important region ROI5 having a width equivalent to a vehicle width of the bus 30c.

The important region specification section 102a may acquire operation information of a handle of the bus 30c from the V2X information provision apparatus 200a, and identify a traveling direction of the bus 30c in accordance with the operation information of the handle to specify an important region.

The important region specification section 102a may acquire acceleration or operation information of an accelerator of the bus 30c from the V2X information provision apparatus 200a, and identify a traveling speed of the bus from the information to specify an important region.

The important region specification section 102a may acquire a vehicle type of a vehicle from the V2X information provision apparatus 200a, and set a width and a size of an important region according to the vehicle type.

In the above description, the V2X information is exemplified by a speed, a vehicle type, acceleration, a handle, an accelerator, blinkers, and the like of a vehicle. However, these are merely examples, and other V2X information can be used to specify an important region. For example, in a case where V2X information includes an attribute of a driver or the like, the important region specification section 102a may specify an important region based on the attribute (age, driving experience, license type, accident record, and the like) of the driver. For example, for a driver whose driving experience is short or an aged driver, the important region specification section 102a specifies, on the front side of the vehicle in the traveling direction, an important region which is wider than usual. With the above configuration, a control center or the like can carry out road abnormality monitoring or the like based on a broader important region, and notify a driver or the like of a result thereof.

In a case where an attribute of a vehicle or the like is included in V2X information, the important region specification section 102a may specify an important region based on the attribute of the vehicle (i.e., a vehicle type, whether or not the vehicle is an emergency vehicle, or the like). With the above configuration, it is possible to make an important region specified for an ordinary vehicle different from an important region specified for an emergency vehicle (ambulance, fire engine, and the like). For example, for an ambulance, the important region specification section 102a specifies an important region larger than that for an ordinary vehicle on the front side of the vehicle in the traveling direction. With the above configuration, a control center or the like can carry out road abnormality monitoring or the like based on a broader important region, and notify a driver or the like of a result thereof.

As described above, according to the important region specification apparatus 100a in accordance with the present example embodiment, the important region specification section 102a specifies an important region in an image-capturable region of a camera based on position information of a vehicle and at least one selected from the group consisting of a speed, a vehicle type, and acceleration of the vehicle and pieces of operation information of a handle, an accelerator, and blinkers. Therefore, the important region specification section 102a can more appropriately specify an important region based on operation information.

### Fifth Example Embodiment

In the foregoing first through fourth example embodiments, the configuration has been described in which the camera 140 is a fixed camera that is provided at an intersection. However, the camera for taking an image in which an important region is specified is not limited to the fixed camera. An important region specification apparatus in accordance with the present example embodiment specifies an important region in, for example, an image taken by an in-vehicle camera mounted on a vehicle.

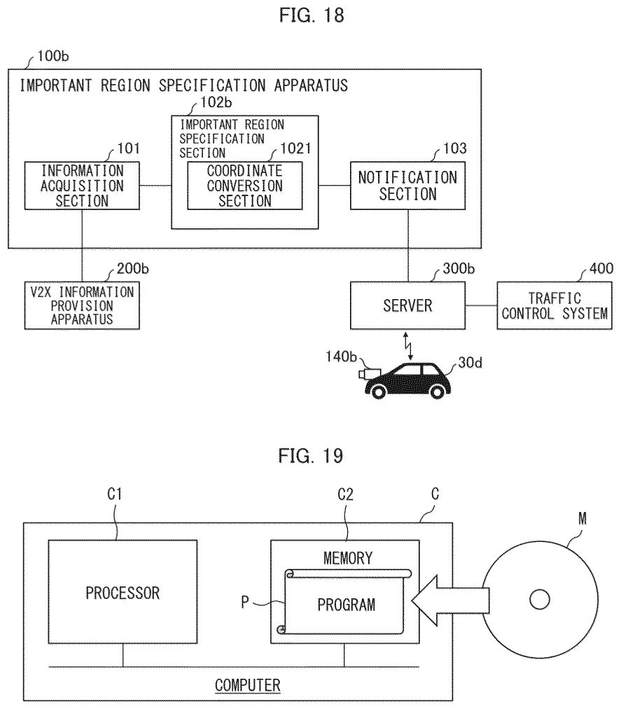

FIG. 18 is a diagram illustrating, with a peripheral configuration, a configuration of an important region specification apparatus 100b in accordance with the fifth example embodiment of the present invention. As illustrated in FIG. 18, the important region specification apparatus 100b in accordance with the present example embodiment includes an information acquisition section 101, an important region specification section 102b, and a notification section 103. The same reference numerals are given to constituent elements which have functions identical with those described in the third and fourth example embodiments, and descriptions as to such constituent elements are omitted as appropriate.

In the present example embodiment, an in-vehicle camera is mounted on a vehicle 30d instead of the camera 140 that is provided so as to be able to take an image of a road. A V2X information provision apparatus 200b provides the important region specification apparatus 100b with V2X information including position information of a vehicle around the vehicle 30d. Then, the important region specification apparatus 100b specifies, with reference to the V2X information provided from the V2X information provision apparatus 200b, an important region in an image taken by the in-vehicle camera 140b.

The V2X information provision apparatus 200b ascertains a position of the vehicle 30d, and provides the important region specification apparatus 100b with V2X information including a position of another vehicle located around the vehicle 30d on which the in-vehicle camera 140b is mounted.

The important region specification apparatus 100b specifies, with reference to the V2X information acquired from the V2X information provision apparatus 200b, an important region in an image taken by the in-vehicle camera 140b which has been provided from the vehicle 30d via a server 300b, and notifies the server 300b of the important region. Note that the important region specification apparatus 100b in accordance with the present example embodiment carries out conversion of coordinates or the like while taking into consideration the fact that an image-capturable range of the in-vehicle camera 140b changes as the vehicle 30d moves. For example, the important region specification section 102b specifies, as an important region, a rectangular region in front of the vehicle 30d in the traveling direction, based on position information of the vehicle 30d. The important region is represented by a relative position (e.g., a rectangular region having a width of 2 m and a length of 5 m from a front end of the vehicle) from a position of the vehicle. Then, the important region specification section 102b converts the important region into coordinates in an image taken by the in-vehicle camera 140b.

For example, it is assumed that an important region is specified in a target space in an image-capturable range illustrated in the left part of FIG. 9 based on the position information of the vehicle 30d acquired from the V2X information provision apparatus 200b. In this case, a coordinate conversion section 1021 converts latitude-longitude position information in the target space in the image-capturable range illustrated in the left part of FIG. 9 into a relative position with respect to a lower left position of the left part. For example, the coordinate conversion section 1021 defines lower left coordinates as (0,0) and upper right coordinates as (1023,1023) in a target space of the image-capturable range, and calculates relative positions of four corners of the important region.

The coordinate conversion section 1021 stores, in advance, a table indicating a correspondence between a relative position in a target space in the image-capturable range and corresponding coordinates in an image taken by the camera 140b. With reference to the table, the coordinate conversion section 1021 converts relative positions of four corners of an important region in the target space in the image-capturable range into corresponding coordinates in the image taken by the camera 140b. In a case where the coordinates of the important region in the target space in the image-capturable range are between relative coordinates that are stored in the table, an interpolation process may be carried out to convert the coordinates into corresponding coordinates in the image taken by the camera 140b.

The coordinate conversion section 1021 converts the important region which is described in such a latitude and a longitude into coordinates in an image taken by the camera 140b. For example, the right part of FIG. 9 indicates an important region which is defined by four points. Coordinates (x1,y1), (x2,y2), (x3,y3), and (x4,y4) in the important region in the right part of FIG. 9 correspond to coordinates of the four corners of the important region in the left part of FIG. 9.

The server 300b transmits the image received from the in-vehicle camera 140b to the important region specification apparatus 100b. The server 300b also transmits, to a traffic control system 400, the image received from the in-vehicle camera 140b and information of the important region sent from the important region specification apparatus 100b.

The traffic control system 400 uses the image received from the in-vehicle camera 140b and the information of the important region sent from the important region specification apparatus 100b to present information or the like to an operator who carries out traffic control work. For example, the traffic control system 400 locally carries out sharpening, object recognition, or the like in the image obtained from the in-vehicle camera 140b using the information of the important region sent from the important region specification apparatus 100b.

As described above, according to the important region specification apparatus 100b in accordance with the present example embodiment, the important region specification section 102b specifies an important region in an image taken by the in-vehicle camera 140b. Therefore, it is possible to provide information related to remote support and the like to a self-driving vehicle, a vehicle of a driver who is not familiar with driving the vehicle, or the like.

### [Software Implementation Example]

The functions of part of or all of the important region specification systems 1 and 1a and the important region specification apparatuses 10, 10a, 100, 100a, and 100b can be implemented by hardware such as an integrated circuit (IC chip) or can be alternatively implemented by software.

In the latter case, the important region specification systems 1 and 1a and the important region specification apparatuses 10, 10a, 100, 100a, and 100b are each implemented by, for example, a computer that executes instructions of a program that is software realizing the foregoing functions. FIG. 19 illustrates an example of such a computer (hereinafter, referred to as “computer C”). The computer C includes at least one processor C1 and at least one memory C2. The memory C2 stores a program P for causing the computer C to function as each of the important region specification systems 1 and 1a and the important region specification apparatuses 10, 10a, 100, 100a, and 100b. In the computer C, the processor C1 reads the program P from the memory C2 and executes the program P, so that the functions of the important region specification systems 1 and 1a and the important region specification apparatuses 10, 10a, 100, 100a, and 100b are implemented.

Examples of the processor C1 include a central processing unit (CPU), a graphic processing unit (GPU), a digital signal processor (DSP), a micro processing unit (MPU), a floating point number processing unit (FPU), a physics processing unit (PPU), a microcontroller, and a combination thereof. Examples of the memory C2 include a flash memory, a hard disk drive (HDD), a solid state drive (SSD), and a combination thereof.

Note that the computer C can further include a random access memory (RAM) in which the program P is loaded when the program P is executed and in which various kinds of data are temporarily stored. The computer C can further include a communication interface for carrying out transmission and reception of data with other apparatuses. The computer C can further include an input-output interface for connecting input-output apparatuses such as a keyboard, a mouse, a display and a printer.

The program P can be stored in a computer C-readable, non-transitory, and tangible storage medium M. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communication network, a broadcast wave, or the like. The computer C can obtain the program P also via such a transmission medium.

### [Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### [Additional Remark 2]

Some or all of the foregoing example embodiments can also be described as below. Note, however, that the present invention is not limited to the following supplementary notes.

### (Supplementary Note 1)

An important region specification system, including: an information acquisition means for acquiring position information of a vehicle; an important region specification means for specifying an important region in an image-capturable region of a camera based on the position information of the vehicle; and an important region notification means for notifying an image processing apparatus, which processes an image taken by the camera, of the important region.

According to the above configuration, the important region specification means can appropriately specify an image region that is important for a vehicle. The important regions can be used in visual monitoring of an image by a video user (e.g., a human) and in various kinds of image processing by a computer.

### (Supplementary Note 2)

The important region specification system according to supplementary note 1, in which: the important region specification means specifies, as the important region based on the position information of the vehicle, a region to which the vehicle is to travel.

According to the above configuration, the important region specification means can appropriately specify an image region that is important for a vehicle.

### (Supplementary Note 3)

The important region specification system according to supplementary note 2, in which: the important region specification means specifies a range, which is to be set to the important region, based on the position information of the vehicle, and specifies the important region by converting the range into coordinates in the image taken by the camera.

According to the above configuration, the important region can be specified at an appropriate position in an image taken by the camera.

### (Supplementary Note 4)

The important region specification system according to any one of supplementary notes 1 through 3, in which: the information acquisition means acquires at least one selected from the group consisting of a speed, a vehicle type, and acceleration of the vehicle and pieces of operation information of a handle, an accelerator, and blinkers of the vehicle; and the important region specification means specifies an important region in the image-capturable region of the camera based on the position information of the vehicle and the at least one selected from the group consisting of a speed, a vehicle type, and acceleration of the vehicle and pieces of operation information of a handle, an accelerator, and blinkers of the vehicle.

According to the above configuration, the important region specification means can more appropriately specify an important region based on the operation information.

### (Supplementary Note 5)

The important region specification system according to any one of supplementary notes 1 through 4, further including: an image quality adjustment means for changing, based on information of the important region which has been specified, image quality of the image taken by the camera.

According to the above configuration, the image quality adjustment means changes image quality so that deterioration of an image in the important region is suppressed, and this makes it possible to more minutely carry out visual monitoring of an image by a human and various kinds of image processing by a computer.

### (Supplementary Note 6)

The important region specification system according to any one of supplementary notes 1 through 5, in which: the camera is a camera which is provided at an intersection or a camera which is mounted on a vehicle.

### (Supplementary Note 7)

The important region specification system according to any one of supplementary notes 1 through 6, further including: a display means for displaying an image taken by the camera, the display means displaying the image while using the important region.

According to the above configuration, the display means displays, while using the important region, an image taken by the camera. Therefore, it is possible to more minutely carry out visual monitoring of an image and the like by a human.

### (Supplementary Note 8)

An important region specification apparatus, including: an information acquisition means for acquiring position information of a vehicle; an important region specification means for specifying an important region in an image-capturable region of a camera based on the position information of the vehicle; and an important region notification means for notifying an image processing apparatus, which processes an image taken by the camera, of the important region.

According to the above configuration, the important region specification means can appropriately specify an image region that is important for a vehicle. The important regions can be used in visual monitoring of an image by a video user (e.g., a human) and in various kinds of image processing by a computer.

### (Supplementary Note 9)

The important region specification apparatus according to supplementary note 8, in which: the important region specification means specifies, as the important region based on the position information of the vehicle, a region to which the vehicle is to travel.

According to the above configuration, the important region specification means can appropriately specify an image region that is important for a vehicle.

### (Supplementary Note 10)

The important region specification apparatus according to supplementary note 9, in which: the important region specification means specifies a range, which is to be set to the important region, based on the position information of the vehicle, and specifies the important region by converting the range into coordinates in the image taken by the camera.

According to the above configuration, the important region can be specified at an appropriate position in an image taken by the camera.

### (Supplementary Note 11)

The important region specification apparatus according to any one of supplementary notes 8 through 10, in which: the information acquisition means acquires at least one selected from the group consisting of a speed, a vehicle type, and acceleration of the vehicle and pieces of operation information of a handle, an accelerator, and blinkers of the vehicle; and the important region specification means specifies an important region in the image-capturable region of the camera based on the position information of the vehicle and the at least one selected from the group consisting of a speed, a vehicle type, and acceleration of the vehicle and pieces of operation information of a handle, an accelerator, and blinkers of the vehicle.

According to the above configuration, the important region specification means can more appropriately specify an important region based on the operation information.

### (Supplementary Note 12)

The important region specification apparatus according to any one of supplementary notes 8 through 11, further including: an image quality adjustment means for changing, based on information of the important region which has been specified, image quality of the image taken by the camera.

According to the above configuration, the image quality adjustment means changes image quality so that deterioration of an image in the important region is suppressed, and this makes it possible to more minutely carry out visual monitoring of an image by a human and various kinds of image processing by a computer.

### (Supplementary Note 13)

The important region specification apparatus according to any one of supplementary notes 8 through 12, in which: the camera is a camera which is provided at an intersection or a camera which is mounted on a vehicle.

### (Supplementary Note 14)

The important region specification apparatus according to any one of supplementary notes 8 through 13, further including: a display means for displaying an image taken by the camera, the display means displaying the image while using the important region.

According to the above configuration, the display means displays, while using the important region, an image taken by the camera. Therefore, it is possible to more minutely carry out visual monitoring of an image and the like by a human.

### (Supplementary Note 15)

An important region specification method, including: acquiring position information of a vehicle; specifying an important region in an image-capturable region of a camera based on the position information of the vehicle; and notifying an image processing apparatus, which processes an image taken by the camera, of the important region.

According to the above configuration, it is possible to appropriately specify an image region that is important for a vehicle. The important regions can be used in visual monitoring of an image by a video user (e.g., a human) and in various kinds of image processing by a computer.

### (Supplementary Note 16)

The important region specification method according to supplementary note 15, in which: in the important region specification method, a region to which the vehicle is to travel is specified as the important region based on the position information of the vehicle.

According to the above configuration, it is possible to appropriately specify an image region that is important for a vehicle.

### (Supplementary Note 17)

The important region specification method according to supplementary note 16, in which: a range, which is to be set to the important region, is specified based on the position information of the vehicle; and the important region is specified by converting the range into coordinates in the image taken by the camera.

According to the above configuration, the important region can be specified at an appropriate position in an image taken by the camera.

### (Supplementary Note 18)

The important region specification method according to any one of supplementary notes 15 through 17, in which: at least one selected from the group consisting of a speed, a vehicle type, and acceleration of the vehicle and pieces of operation information of a handle, an accelerator, and blinkers of the vehicle is acquired; and an important region in the image-capturable region of the camera is specified based on the position information of the vehicle and the at least one selected from the group consisting of a speed, a vehicle type, and acceleration of the vehicle and pieces of operation information of a handle, an accelerator, and blinkers of the vehicle.

According to the above configuration, it is possible to more appropriately specify an important region based on the operation information.

### (Supplementary Note 19)

The important region specification method according to any one of supplementary notes 15 through 18, further including: changing, based on information of the important region which has been specified, image quality of the image taken by the camera.

According to the above configuration, by changing image quality so that deterioration of an image in the important region is suppressed, it is possible to more minutely carry out visual monitoring of an image by a human and various kinds of image processing by a computer.

### (Supplementary Note 20)

The important region specification method according to any one of supplementary notes 15 through 19, in which: the camera is a camera which is provided at an intersection or a camera which is mounted on a vehicle.

### (Supplementary Note 21)

A program for causing a computer to carry out: a process of acquiring position information of a vehicle; a process of specifying an important region in an image-capturable region of a camera based on the position information of the vehicle; and a process of notifying an image processing apparatus, which processes an image taken by the camera, of the important region.

According to the above configuration, it is possible to appropriately specify an image region that is important for a vehicle. The important regions can be used in visual monitoring of an image by a video user (e.g., a human) and in various kinds of image processing by a computer.

### (Supplementary Note 22)

An important region specification system including at least one processor, the at least one processor carrying out: a process of acquiring position information of a vehicle; a process of specifying an important region in an image-capturable region of a camera based on the position information of the vehicle; and a process of notifying an image processing apparatus, which processes an image taken by the camera, of the important region.

Note that the important region specification system can further include a memory. The memory can store a program for causing the at least one processor to carry out the acquisition process, the specification process, and the notification process. The program can be stored in a computer-readable non-transitory tangible storage medium.

### (Supplementary Note 23)

An important region specification apparatus including at least one processor, the at least one processor carrying out: a process of acquiring position information of a vehicle; a process of specifying an important region in an image-capturable region of a camera based on the position information of the vehicle; and a process of notifying an image processing apparatus, which processes an image taken by the camera, of the important region.

Note that the important region specification apparatus can further include a memory. The memory can store a program for causing the at least one processor to carry out the acquisition process, the specification process, and the notification process. The program can be stored in a computer-readable non-transitory tangible storage medium.

### REFERENCE SIGNS LIST

1, 1a: Important region specification system
10, 10a, 100, 100a, 100b: Important region
specification apparatus
11: Information acquisition means
12: Important region specification means
13: Important region notification means
14: Image quality adjustment means
15: Display means
30a, 30b, 30d: Vehicle
30c: Bus
140: Camera
140b: In-vehicle camera
101: Information acquisition section
102, 102a, 102b: Important region specification
section
103: Notification section
200, 200a, 200b: V2X information provision apparatus
300, 300b: Server
400: Traffic control system
1021: Coordinate conversion section
ROI1 through ROI3, ROI5, ROI1a: Important region

What is claimed is:

1. An important region specification system, comprising at least one processor, the at least one processor carrying out:
acquiring position information of a vehicle;
specifying an important region in an image-capturable region of a camera based on the position information of the vehicle; and
notifying an image processing apparatus, which processes an image taken by the camera, of the important region.

2. The important region specification system according to claim 1, wherein:
in the specifying the important region, the at least one processor specifies, as the important region based on the position information of the vehicle, a region to which the vehicle is to travel.

3. The important region specification system according to claim 2, wherein:
in the specifying the important region, the at least one processor specifies a range, which is to be set to the important region, based on the position information of the vehicle, and specifies the important region by converting the range into coordinates in the image taken by the camera.

4. The important region specification system according to claim 1, wherein:
in the acquiring the position information, the at least one processor means acquires at least one selected from the group consisting of a speed, a vehicle type, and acceleration of the vehicle and pieces of operation information of a handle, an accelerator, and blinkers of the vehicle; and
in the specifying the important region, the at least one processor specifies an important region in the image-capturable region of the camera based on the position information of the vehicle and the at least one selected from the group consisting of a speed, a vehicle type, and acceleration of the vehicle and pieces of operation information of a handle, an accelerator, and blinkers of the vehicle.

5. The important region specification system according to claim 1, wherein:
the at least one processor further carries out changing, based on information of the important region which has been specified, image quality of the image taken by the camera.

6. The important region specification system according to claim 1, wherein:
the camera is a camera which is provided at an intersection or a camera which is mounted on a vehicle.

7. The important region specification system according to claim 1, wherein:
the at least one processor further carries out displaying an image taken by the camera,
in the displaying, the at least one processor displaying the image while using the important region.

8. An important region specification apparatus, comprising at least one processor, the at least one processor carrying out:
acquiring position information of a vehicle;
specifying an important region in an image-capturable region of a camera based on the position information of the vehicle; and
notifying an image processing apparatus, which processes an image taken by the camera, of the important region.

9. The important region specification apparatus according to claim 8, wherein:
in the specifying the important region, the at least one processor specifies, as the important region based on the position information of the vehicle, a region to which the vehicle is to travel.

10. The important region specification apparatus according to claim 9, wherein:
in the specifying the important region, the at least one processor specifies a range, which is to be set to the important region, based on the position information of the vehicle, and specifies the important region by converting the range into coordinates in the image taken by the camera.

11. The important region specification apparatus according to claim 8, wherein:
in the acquiring the position information, the at least one processor acquires at least one selected from the group consisting of a speed, a vehicle type, and acceleration of the vehicle and pieces of operation information of a handle, an accelerator, and blinkers of the vehicle; and
in the specifying the important region, the at least one processor specifies an important region in the image-capturable region of the camera based on the position information of the vehicle and the at least one selected from the group consisting of a speed, a vehicle type, and acceleration of the vehicle and pieces of operation information of a handle, an accelerator, and blinkers of the vehicle.

12. The important region specification apparatus according to claim 8, wherein:
the at least one processor further carries out changing, based on information of the important region which has been specified, image quality of the image taken by the camera.

13. The important region specification apparatus according to claim 8, wherein:
the camera is a camera which is provided at an intersection or a camera which is mounted on a vehicle.

14. The important region specification apparatus according to claim 8, wherein:
the at least one processor further carries out displaying an image taken by the camera,
in the displaying, the at least one processor displaying the image while using the important region.

15. An important region specification method, comprising:
acquiring position information of a vehicle;
specifying an important region in an image-capturable region of a camera based on the position information of the vehicle; and
notifying an image processing apparatus, which processes an image taken by the camera, of the important region.

16. The important region specification method according to claim 15, wherein:
in the specifying the important region, a region to which the vehicle is to travel is specified as the important region based on the position information of the vehicle.

17. The important region specification method according to claim 16, wherein:
a range, which is to be set to the important region, is specified based on the position information of the vehicle; and
the important region is specified by converting the range into coordinates in the image taken by the camera.

18. The important region specification method according to claim 15, wherein:
at least one selected from the group consisting of a speed, a vehicle type, and acceleration of the vehicle and pieces of operation information of a handle, an accelerator, and blinkers of the vehicle is acquired; and
an important region in the image-capturable region of the camera is specified based on the position information of the vehicle and the at least one selected from the group consisting of a speed, a vehicle type, and acceleration of the vehicle and pieces of operation information of a handle, an accelerator, and blinkers of the vehicle.

19. The important region specification method according to claim 15, further comprising:
changing, based on information of the important region which has been specified, image quality of the image taken by the camera.

20. The important region specification method according to claim 15, wherein:
the camera is a camera which is provided at an intersection or a camera which is mounted on a vehicle.

21. (canceled)
